(19) United States
(12) Patent Application Publication
(10) Pub. No.: US 2013/0087543 A1
(43) Pub. Date: Apr. 11, 2013

(54) APPARATUS AND METHOD FOR POST WELD LASER RELEASE OF GAS BUILD UP IN A GMAW WELD

(71) Applicants: Paul E. Denney, Bay Village, OH (US); Steven R. Peters, Huntsburg, OH (US)

(72) Inventors: Paul E. Denney, Bay Village, OH (US); Steven R. Peters, Huntsburg, OH (US)

(73) Assignee: LINCOLN GLOBAL, INC., City of Industry, CA (US)

(21) Appl. No.: 13/411,428

(22) Filed: Mar. 2, 2012

Related U.S. Application Data
(63) Continuation-in-part of application No. 13/267,641, filed on Oct. 6, 2011.

(51) Int. Cl. B23K 9/00

(52) U.S. Cl. 219/137 R; 219/136

(57) ABSTRACT

A system and method is provided where a work piece is welded at high speeds with minimal porosity and spatter. In embodiments, the work piece is welded with an arc welding process to create a weld puddle and the weld puddle is irradiated by a energy beam downstream of the arc welding operation, such that high welding speeds are attained. The high energy heat source is positioned downstream of the welding operation to input energy into the weld puddle to change its shape or characteristics to optimize bead shape and/or bead quality.

### PRIORITY

The present invention is a continuation-in-part of U.S. patent application Ser. No. 13/267,641, filed on Oct. 6, 2011, the disclosure of which is incorporated herein by reference, in its entirety.

### BACKGROUND OF THE INVENTION

1 Field of the Invention

Systems and methods of the present invention relate to welding and joining, and more specifically to the welding and joining of coated materials.

2. Description of the Related Art

Many welded structures are used in environments which require surface coatings to prevent corrosion. For example, the deposition of zinc on steel (through galvanization or galvannealing) is commonly used to protect the steel from corrosion when the steel is exposed to the environment. It is very difficult to galvanize materials after they are welded in place and as such most steel components are galvanized prior to welding. However, welding coated materials can be a difficult process because the coating can interfere with the welding process and degrade the quality of the weld. For example, the zinc in galvanization is vaporized because of the heat of a welding arc and this vaporization can cause significant spatter or can be trapped in the weld puddle causing porosity in the weld. Because of this the welding of coated materials is considerably slower than welding uncoated materials.

### BRIEF SUMMARY OF THE INVENTION

Embodiments of the present invention include equipment and methods of welding at least one work piece with an arc welding process such that a liquid weld puddle is created from the at least one work piece and the welding is being performed in a travel direction. Also, an energy beam is directed to a surface of the weld puddle downstream of the arc welding process, relative to the travel direction, such that the energy beam adds heat energy to the weld puddle to modify a shape of the weld puddle. A weld joint created by the process has a cross-sectional porosity of no more than 30% and a length porosity of no more than 30%.

### BRIEF DESCRIPTION OF THE DRAWINGS

The above and/or other aspects of the invention will be more apparent by describing in detail exemplary embodiments of the invention with reference to the accompanying drawings, in which:

FIG. 1 is a diagrammatical representation of a weld joint made from an arc welding process;

FIGS. 2A to 2C are diagrammatical representations of a cleaning operation in accordance with exemplary embodiments of the present invention;

FIG. 3A to 3B are diagrammatical representations of weld joint made in accordance with an exemplary embodiment of the present invention;

FIG. 4 is a diagrammatical representation of a further exemplary embodiment of a weld joint made according to an embodiment of the present invention;

FIG. 5 is a diagrammatical representation of an exemplary embodiment of a welding system according to the present invention;

FIG. 6 is a diagrammatical representation of an exemplary embodiment of a portion of a welding system;

FIG. 7 is a diagrammatical representation of another exemplary embodiment of a welding system of the present invention;

FIG. 8 is a diagrammatical representation of a further exemplary embodiment of a welding system of the present invention;

FIG. 9 is a diagrammatical representation of an integral welding head unit in accordance with an exemplary embodiment of the present invention;

FIG. 10 is a diagrammatical representation of an additional exemplary embodiment of the present invention;

FIG. 11 is a diagrammatical representation of a welding operation using the exemplary embodiment of FIG. 10;

FIG. 12 is a diagrammatical representation of a weld puddle formed by the exemplary embodiment of FIG. 10;

FIG. 13 is a diagrammatical representation of another exemplary welding system of the present invention; and

FIG. 14 is a diagrammatical representation of a welding system in accordance with yet another exemplary embodiment of the present invention.

### DETAILED DESCRIPTION OF EXEMPLARY EMBODIMENTS

Exemplary embodiments of the invention will now be described below by reference to the attached Figures. The described exemplary embodiments are intended to assist the understanding of the invention, and are not intended to limit the scope of the invention in any way. Like reference numerals refer to like elements throughout.

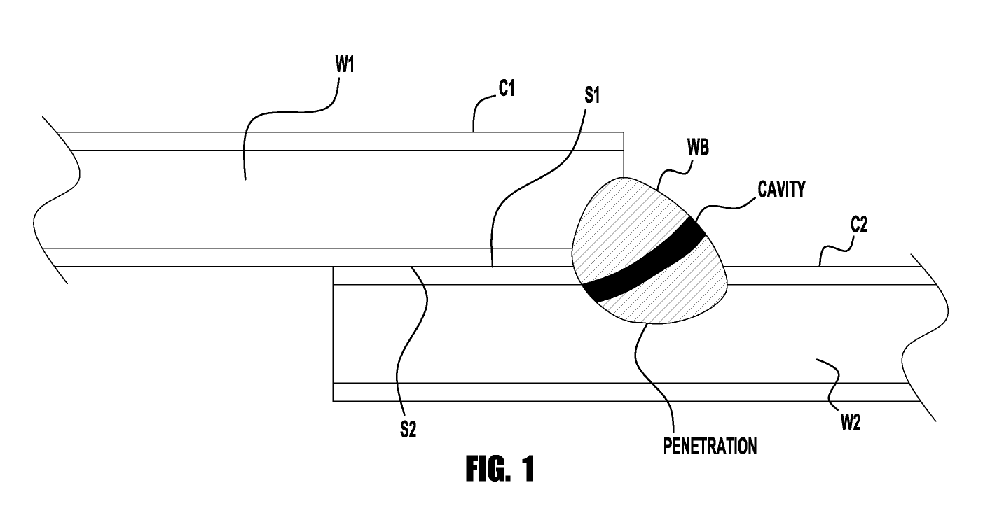

FIG. 1 depicts a typical welded lap joint where a first work piece W1 is placed partially on top of a second work piece W2 and the two are welded with a weld bead WB. In the welding industry, this type of connection is commonly referred to as a lap joint. Lap joints are common in the automotive industry. In addition to lap joints, embodiments of the present invention can weld multiple different types of joints as well, including: fillet joints, joggle joints, butt joints, etc. As shown in FIG. 1, at least one of the work pieces has a coating C1/C2 on the surfaces to be welded, where the coatings have a different material composition than the work piece. As an example, this coating can be corrosion resistant coating, such as galvanization. Because the work pieces are coated the surfaces of the work pieces which contact each other S1 and S2 also have coatings on them. During welding the heat of the welding arc plasma vaporizes the coatings C1/C2. The vaporized coatings C1/C2 which are not covered by the overlapping of the work pieces typically is removed from the weld zone either by fume extraction or simply dissipates such that the vapor does not interfere with the weld. However, the coatings C1/C2 which are on the contact surfaces S1/S2 are also vaporized because of the typical depth of penetration by the weld bead WB. However, the vaporized coatings from the contact surfaces S1/S2 are distant from the surface of the weld puddle during welding and as such must travel through the molten puddle to try to escape the weld puddle before the bead solidifies. However, if the welding speed is too fast the puddle solidifies before the vaporized coatings can escape. This leads to porosity in the weld bead. This porosity can be especially bad when a bubble leaves a trail in the weld puddle which does not close behind the bubble. The cavities created by escaping vaporized coatings can significantly degrade the quality of a weld.

Because of these issues with porosity, the welding of coated work pieces must be significantly slowed, as compared to the welding of non-coated work pieces. The slow pace can provide sufficient time for the vaporized coatings to escape the molten weld puddle. However, these slow speeds tend to increase the heat input into the weld and diminish the overall speed and efficiency of the welding operation. For example, when welding galvanized steel the typical travel speeds are 15 to 25 in/min, for work pieces having a thickness of around 1/16 in (16 gauge). Alternatively, welders have often had to grind or sand the coating off of the work piece, which are also time consuming and labor intensive operations.

As discussed earlier, a common coating is galvanization for corrosion resistance. However, other coatings which can cause similar issues include, but are not limited to: paint, stamping lubricants, glass linings, aluminized coatings, surface heat treatment, nitriding or carbonizing treatments, cladding treatments, or other vaporizing coatings or materials.

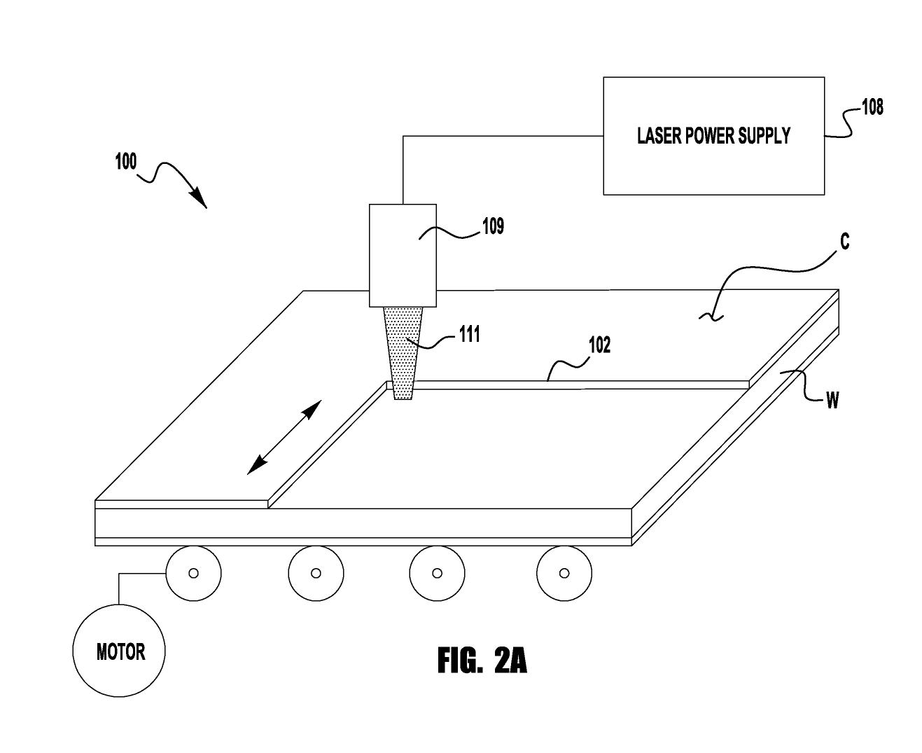

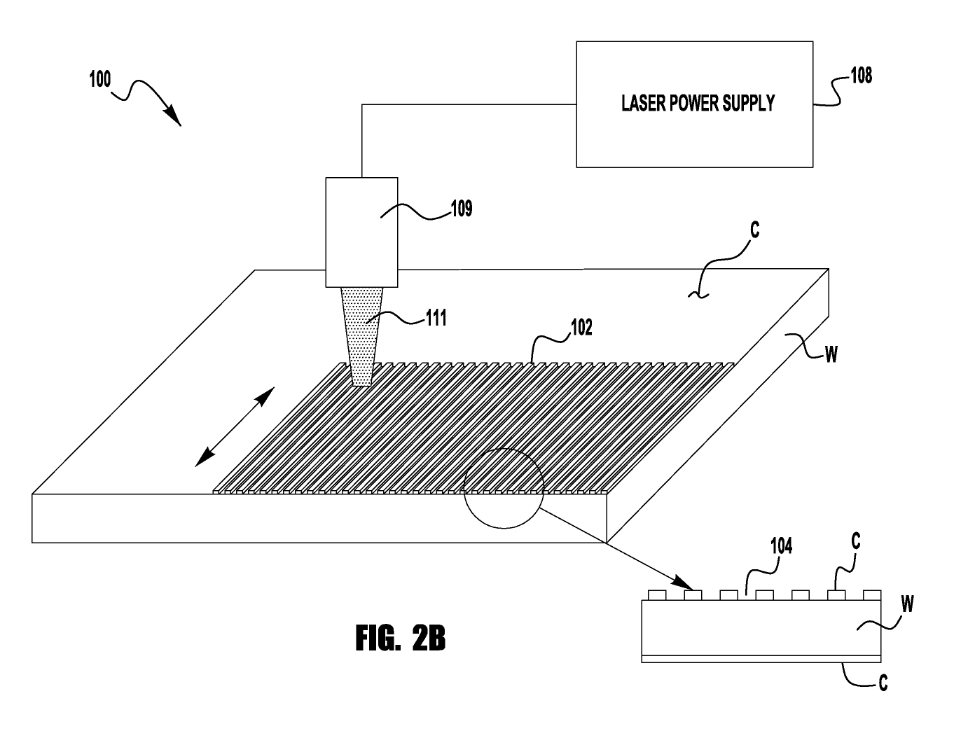

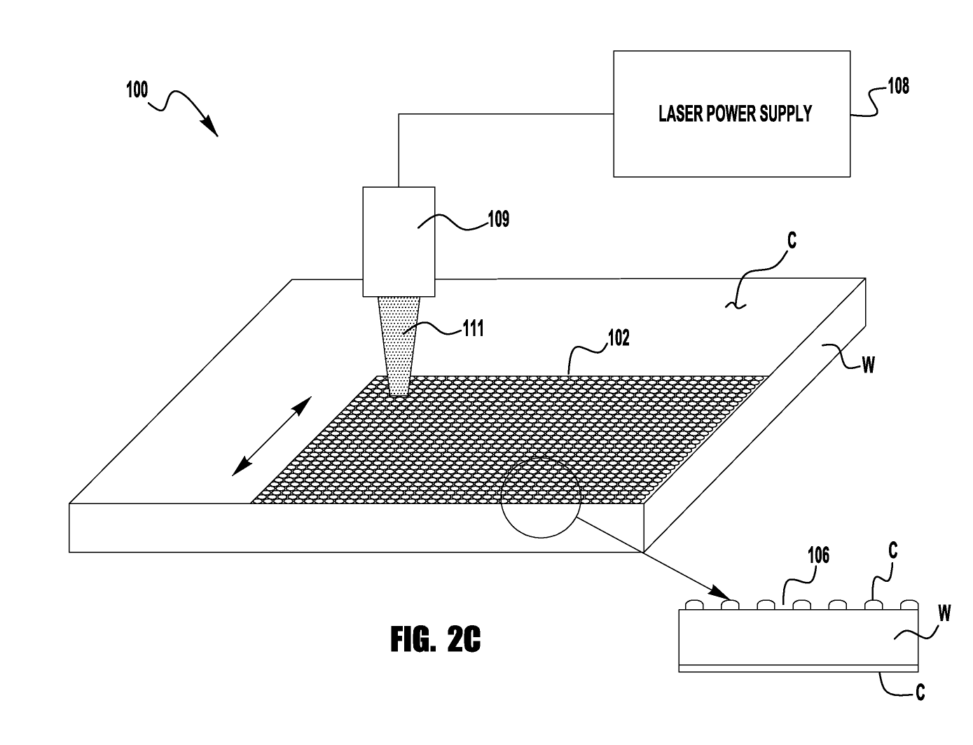

FIGS. 2A through 2C depict an exemplary embodiment of a cleaning system 100 which uses a power supply 108 and a high energy heat source 109 to direct a beam 111 at a surface of a work piece W to ablate the coating C off of an ablation zone 102. The ablation zone 102 is the area on which a subsequent weld will be placed, and is generally defined by a rectangular area which encompasses the travel length and width of the beam 111 on the surface of the work piece W. In exemplary embodiments of the present invention the heat source is a laser 109 (as shown in the Figures). However, other embodiments are not limited to using a laser, and other types of heat sources can be used. Furthermore, many different types of lasers can be used and because of the relatively low temperature requirements to ablate or remove a coating, it is not necessary to use very high energy lasers or heat sources. Such laser/heat source systems (including the heat source 109 and power supply 108) are known and need not be described in detail herein.

In exemplary embodiments, the energy density and focus of the beam 111 should not be too high so as to substantially melt the underlying work piece W, as such melting may interfere with the arc welding process. In exemplary embodiments of the present invention, a laser 109 having a power level of 10 W to 10 kW can be used. In other exemplary embodiments, the laser beam 111 is to have a power density of at least 10⁵ W/cm² and interaction times of no more than 5 ms. In some embodiments the interaction times should be in the range of 1 to 5 ms. The intensity and the interaction times of the laser (or heat source) should be such that appreciable melting of the base material should be avoided. Because the heat required to ablate or remove the coatings are not typically high, this cleaning process will not affect the heat affected zone of a weld joint any more than the welding process itself. The laser can be any known type of laser, including but not limited to carbon dioxide, Nd:YAG, Yb-disk, YB-fiber, fiber delivered or direct diode laser systems. Further, even white light or quartz lamp-type systems can be used if they have sufficient energy. Other embodiments of the system may use other types of high energy sources which are capable of vaporizing the coatings on the surface of the work piece and can include at least one of an electron beam, a plasma arc welding subsystem, a gas tungsten arc welding subsystem, a gas metal arc welding subsystem, a flux cored arc welding subsystem, and a submerged arc welding subsystem serving as the high intensity energy source. However, if higher energy sources are used their energy density and heat must be controlled so as to only vaporize at least a portion of the coating but not substantially melt or scar the underlying work piece.

The lasers employed in embodiments of the present invention can be, but are not limited to: continuous wave, pulsed, q-switched, or other types of lasers that have sufficient peak powers and energy densities to perform the desired cleaning operation. The beam 11 from the laser 109 can be controlled by optics or the power supply 108 to produce a beam cross-section which can be round, rectangular, square, elliptical or other desired shapes. Further, beam splitters can be employed to produce multiple beams or impact spots on the surface. The beam can also be scanned or otherwise manipulated to produce the desired power distribution on the surface for a given interaction time to achieve the desired cleaning.

During ablation, the heat source 109 is powered by the power supply 108 and emits a beam 111 at the surface. It is noted that throughout this application the heat source 109 will also be referred to as a “laser”, but as stated above embodiments of the present invention are not limited to the use of only a laser, but “laser” is used as a discussion of only an exemplary embodiment. During removal the laser 109 emits a beam 111 which impinges on the surface of the work piece to ablate or remove the coating C. As shown in FIG. 2A the beam 111 removes the entire coating C from the surface of the work piece in the ablation zone 102, but does not substantially melt the work piece—which means that no molten puddle of the work piece material is created on the surface of the work piece. The width and the length of the ablation zone 102 are a function of the weld to be performed, and the removal of the coating can occur any time prior to welding.

As shown in FIG. 2A the beam 111 is oscillated back and forth across the ablation zone 102 during the removal process, while the work piece is moved in a travel direction by a motor. However, embodiments of the present invention are not limited in this regard as the laser can be moved in a travel direction while the work piece remains stationary. Further, in other embodiments the beam 111 does not have to be translated. For example, the beam 111 can have a width at the surface such that it ablates the entire width of the ablation zone without having to oscillate. Embodiments of the present invention are not limited in this regard.

In further embodiments of the present invention, it is not required that the beam 111 remove the entire thickness of the coating C. In some welding operations it may only be necessary to remove a partial amount of the coating to achieve an acceptable weld. For example, in some welding operations a minimal level of porosity is acceptable. As such, the speed the process it may only be necessary to ablate up to 50% of the thickness of the coating on the work piece W. In other exemplary embodiments, it may require up to 75% of the thickness of the coating to be ablated.

As shown in FIGS. 2B and 2C, in some exemplary embodiments it is not necessary to ablate the entire area of the ablation zone 102 with the beam. As stated above, some welding operations will produce acceptable weld beads with a minimal level of porosity. Because of this it may not be necessary to remove all of the coating C in the area 102. Thus, in some exemplary embodiments of the present invention, the laser 109 and beam 111 can remove an area of coating C which is less than the overall ablation area 102. As shown in FIG. 2B the beam 111 removes the coating such that cavities 104 (in the shape of grooves) are created in the coating C. In this embodiment the overall cleaning operation is faster than removing all of the coating C. Furthermore, the creation of grooves 104 in the coating can aid in facilitating the removal of vaporized coating from the weld zone during welding. Specifically, as shown in FIG. 2B the grooves can extend to an end of the work piece W, such that when another work piece is placed on the work piece W for welding, the grooves will form cavities between the two work pieces. These cavities provide an exit path for the vaporized coating so that a minimal amount of vaporized coating will enter or try to pass through the weld puddle. Thus, by creation grooves or cavities on the coating C the overall ablation process can be quicker (because less material is being removed) while still permitting high speed and low porosity welds. In exemplary embodiments of the present invention, the beam 111 removes coating C from at least 40% of the area of the ablation zone 102. In other exemplary embodiments, the beam 111 removes coating C from at least 65% of the area of the ablation zone 102.

FIG. 2C depicts another embodiment where the beam 111 cavities 106 in the coating C on the weld surface of the work piece W. The cavities 106 can be of any shape or size to aid in reducing the amount of vaporized coating which enters or tries to pass through the weld puddle to escape.

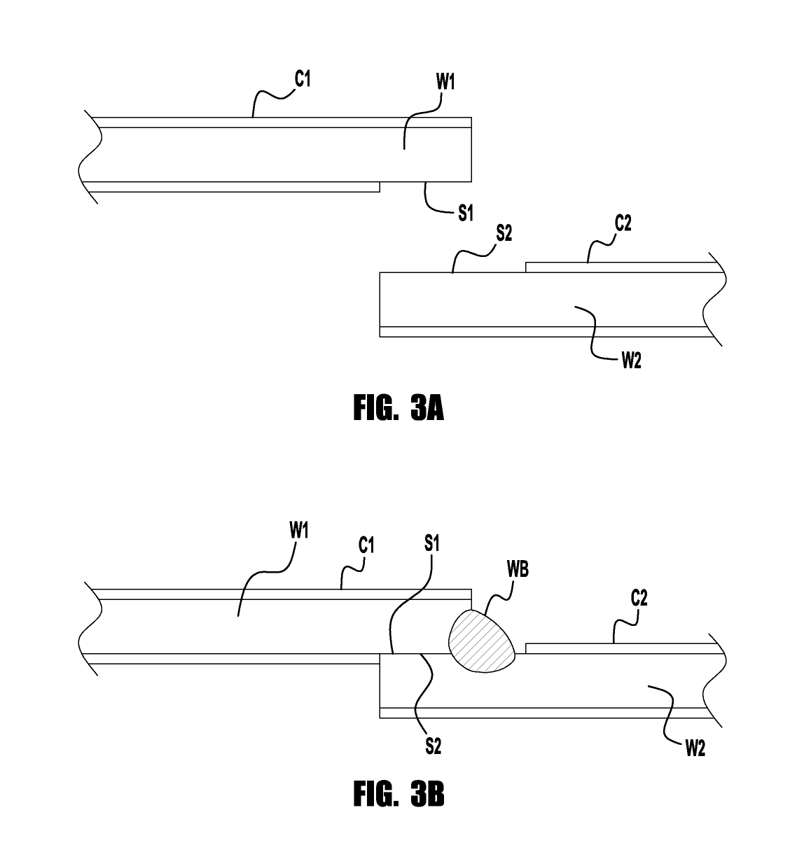

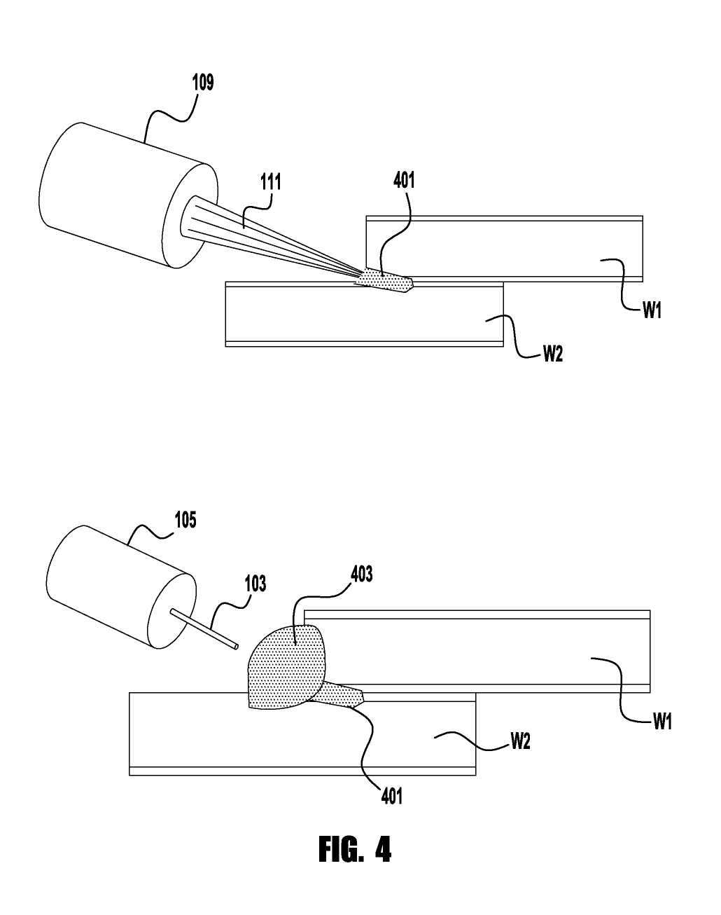

FIGS. 3A and 3B depict work pieces W1 and W2 after the coating has been removed in accordance with embodiments of the present invention. As can be seen the surfaces S1 and S2 not longer have the full/original amount of coating in the weld zone. In these figures the full amount of coating C1/C2 has been removed, but as described above, the full removal may not be necessary in some embodiments. When these work pieces are now welded (FIG. 3B) the penetration of the weld bead does not create vaporized coating material, and thus allows for the speed of the welding operation to be increased, without increasing spatter or porosity. For example, embodiments of the present invention can achieve welding speeds on coated steel materials having a thickness in the range of 1/16″ to 3/16″ of at least 50 in/min with the porosity and spatter levels described above. In some embodiments, the speed is in the range of 50 to 100 in/min, and in other embodiments the speed is in the range of 70 to 100 in/min. In some embodiments these speeds can be achieved while removing the coating and welding at the same time.

In the embodiments discussed above, the work pieces are cleaned by the laser 109 at some point prior to the welding operation. This cleaning operation can occur at a separate work station than the welding operation, but can also occur in line with a weld station to increase operational efficiency. Furthermore, the cleaning can occur simultaneously with the welding operation.

The above embodiments have discussed removal and/or ablation of a surface coating on a work piece W. However, other embodiments of the present invention can used the laser 109 and beam 111 to modify properties or chemical composition of the coating prior to welding. In some embodiments it may not be necessary to remove or ablate the coating, but to alter its composition or change its properties. For example, it is known that the hydrocarbons in paint can interfere with the arc welding process, while the other components of paint are not as problematic. As such, the laser 109 and beam 111 can be used to burn off the hydrocarbons from the paint, thus changing its composition, while the overall thickness of the paint may remain substantially the same as prior to ablation. Thus, other embodiments can be used to alter the properties or composition of the coating, rather than removing it. Of course, this process can be employed using similar characteristics, properties, procedures and equipment as described herein for removal of coatings.

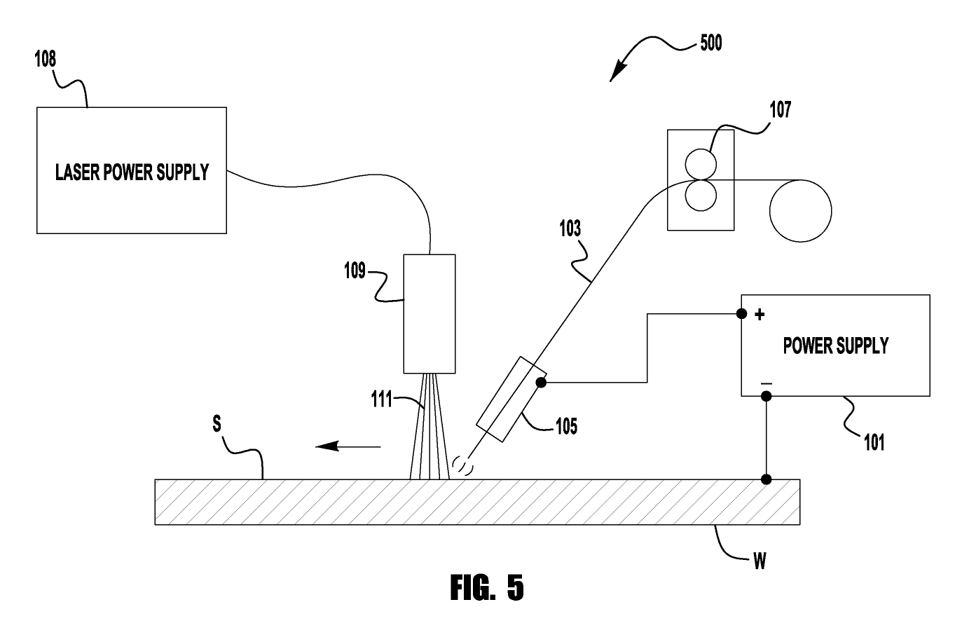

FIG. 4 depicts a welding operation in which the coating(s) are irradiated immediately prior to welding of the joint. Specifically, in the upper figure a beam 111 is directed at the joint such that beam 111 penetrates into the joint to vaporize/remove at least some of the coatings on the work pieces W1/W2. In some embodiments, during this process a laser weld bead 401 can be created which is created by the melting of portions of each of the work pieces W1 and W2. Of course, the depth of penetration of the beam 111 should be controlled such that the work pieces are not structurally compromised. Because the coatings in this region will be vaporized during irradiation, at least some porosity may be present in the bead 401. However, in this embodiment, immediately following the beam irradiation an arc welding operation is conducted at the joint (lower figure). The process of arc welding creates an arc welding bead 403 which consumes at least some of the laser weld bead 401 and because of this subsequent arc welding operation, to the extent any porosity existing the beam weld bead 401 that porosity will have escaped through the arc weld bead 403. Thus, in some exemplary embodiments, the laser cleaning and arc welding can occur at the same time. Such embodiments can significantly improve the efficiency of the welding operation.

In any of the embodiments discussed above, because the laser 109 is removing almost all or all of the coating from the surface, embodiments of the present invention can achieve welding speeds which previously could not have been achieved when welding coated materials. For example, embodiments of the present invention can achieve welding speeds of coated materials at speeds reaching that of uncoated materials. Because arc welding systems are generally known, such stand alone systems need not be depicted or explained herein.

Further, not only can higher weld speeds be achieved, but they can be achieved with minimal levels of porosity and spatter. Porosity of a weld can be determined by examining a cross-section and/or a length of the weld bead to identify porosity ratios. The cross-section porosity ratio is the total area of porosity in a given cross-section over the total cross-sectional area of the weld joint at that point. The length porosity ratio is the total accumulated length of pores in a given unit length of weld joint. Embodiments of the present invention can achieve the above described travel speeds with a cross-sectional porosity between 0 and 30%. Thus, a weld bead with no bubbles or cavities will have 0% porosity. In other exemplary embodiments, the cross-sectional porosity can be in the range of 5 to 20%, and in another exemplary embodiment can be in the range of 0 to 10%. It is understood that in some welding applications some level of porosity is acceptable. Further, in exemplary embodiments of the invention the length porosity of the weld is in the range of 0 to 30%, and can be 5 to 20%. In further exemplary embodiments the length porosity ratio is in the range of 0 to 10%. Thus, for example, welds can be produced in coated materials that have a cross-sectional porosity in the range of 0 to 10% and a length porosity ratio of 0 to 10%.

Furthermore, embodiments of the present invention can weld at the above identified travel speeds with little or no spatter over prior methods of welding coated materials (with the coating in place during welding). Spatter occurs when droplets of the weld puddle are caused to spatter outside of the weld zone. When weld spatter occurs it can compromise the quality of the weld and can cause production delays as it must be typically cleaned off of the work pieces after the welding process. Thus, there is great benefit to welding at high speed with no spatter. Embodiments of the present invention are capable of welding at the above high travel speeds with a spatter factor in the range of 0 to 3, where the spatter factor is the weight of the spatter over a given travel distance X (in mg) over the weight of the consumed filler wire 140 over the same distance X (in Kg). That is:

Spatter Factor=(spatter weight (mg)/consumed filler wire weight (Kg))

The distance X should be a distance allowing for a representative sampling of the weld joint. That is, if the distance X is too short, e.g., 0.5 inches, it may not be representative of the weld. Thus, a weld joint with a spatter factor of 0 would have no spatter for the consumed filler wire over the distance X, and a weld with a spatter of factor of 2.5 had 5 mg of spatter for 2 Kg of consumed filler wire. In an exemplary embodiment of the present invention, the spatter factor is in the range of 0 to 3. In a further exemplary embodiment, the spatter factor is in the range of 0 to 1. In another exemplary embodiment of the present invention the spatter factor is in the range of 0 to 0.5. It should be noted that embodiments of the present invention can achieve the above described spatter factor ranges when welding coated materials where the coating remains on the work piece during the welding operation, while achieving high speeds normally achievable only on uncoated work pieces.

There are a number of methods to measure spatter for a weld joint. One method can include the use of a “spatter boat.” For such a method a representative weld sample is placed in a container with a sufficient size to capture all, or almost all, of the spatter generated by a weld bead. The container or portions of the container—such as the top—can move with the weld process to ensure that the spatter is captured. Typically the boat is made from copper so the spatter does not stick to the surfaces. The representative weld is performed above the bottom of the container such that any spatter created during the weld will fall into the container. During the weld the amount of consumed filler wire is monitored. After the weld is completed the spatter boat is to be weighed by a device having sufficient accuracy to determine the difference, if any, between the pre-weld and post-weld weight of the container. This difference represents the weight of the spatter and is then divided by the amount, in Kg, of the consumed filler wire. Alternatively, if the spatter does not stick to the boat the spatter can be removed and weighed by itself.

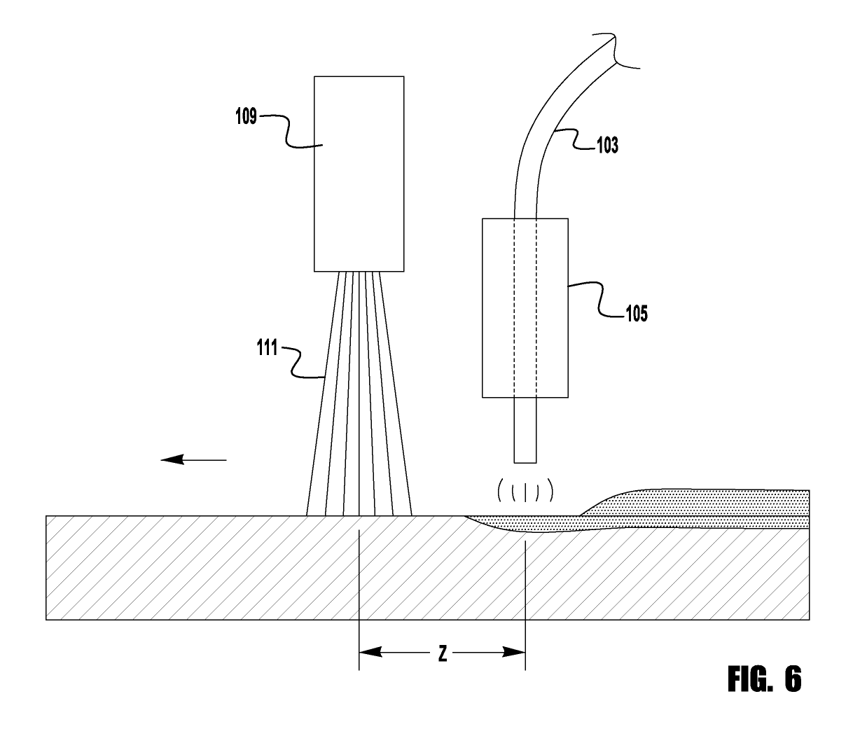

FIG. 5 depicts a welding system 500 in accordance with an exemplary embodiment of the present invention in which the cleaning and welding operation occurs simultaneously. Specifically, the system 500 contains a welding power supply 101 which supplies an arc welding waveform to an electrode 103. The electrode 103 is directed to a work piece W through a contact tip 105 via a wire feeding system 107. This arc welding system can be any known type of arc welding system, including but not limited to gas metal arc welding (GMAW). Not shown is an inert gas or fume extraction system which is often used in arc welding. The power supply 101 creates a welding arc between the electrode 103 and the work piece W such that the electrode 103 is deposited into a weld bead. As described above, the laser 109 irradiates the coating of the work piece W with a beam to remove or ablate the coating prior to welding. The energy level of the beam 111 is such that the there is no appreciable melting of the work piece W. The shape/cross-section of the beam 111 is to be as needed to provide sufficient ablation/removal of the coating prior to welding.

FIG. 6 depicts an aspect of the welding system in accordance with embodiments of the present invention. As shown, the arc welding occurs a distance Z behind the ablation operation. In exemplary embodiments of the present invention, the distance Z is in the range of 0.5 to 6 inches. In other exemplary embodiments, the distance Z is in the range of 0.5 to 3.5 inches. Of course, in other embodiments it is not required that the welding occur immediately after the ablation operation. In fact, the laser ablation can occur at another work station.

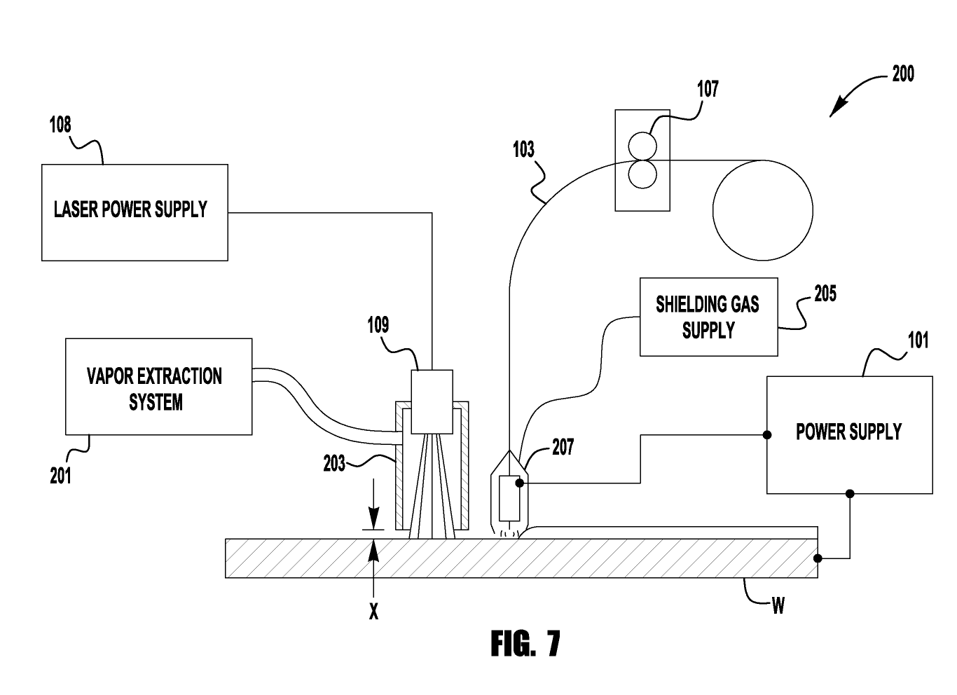

FIG. 7 depicts another exemplary embodiment of a welding system 200 in accordance with the present invention. In this system 200 a vapor extraction system 201 and nozzle 203 are incorporated. The nozzle 203 is positioned such that it can remove any vaporized coating material from the weld zone. This will prevent the vapor from contaminating the weld or otherwise interfering with any shielding that may be needed for the welding operation. In the embodiment shown, the nozzle is coupled to the laser 109 such that the nozzle 203 shrouds the laser beam 111. In an exemplary embodiment, the end of the nozzle 203 is a distance X above the surface of the work piece in a range of 0.125 to 0.5 inches. The distance X should not interfere with the welding operation, but should be sufficient to remove at least some of the vaporized coating during ablation. Also shown in FIG. 4 is a shielding gas supply 205 and nozzle 207 to deliver the shielding gas to the weld. Such systems are generally known and will not be discussed in detail herein.

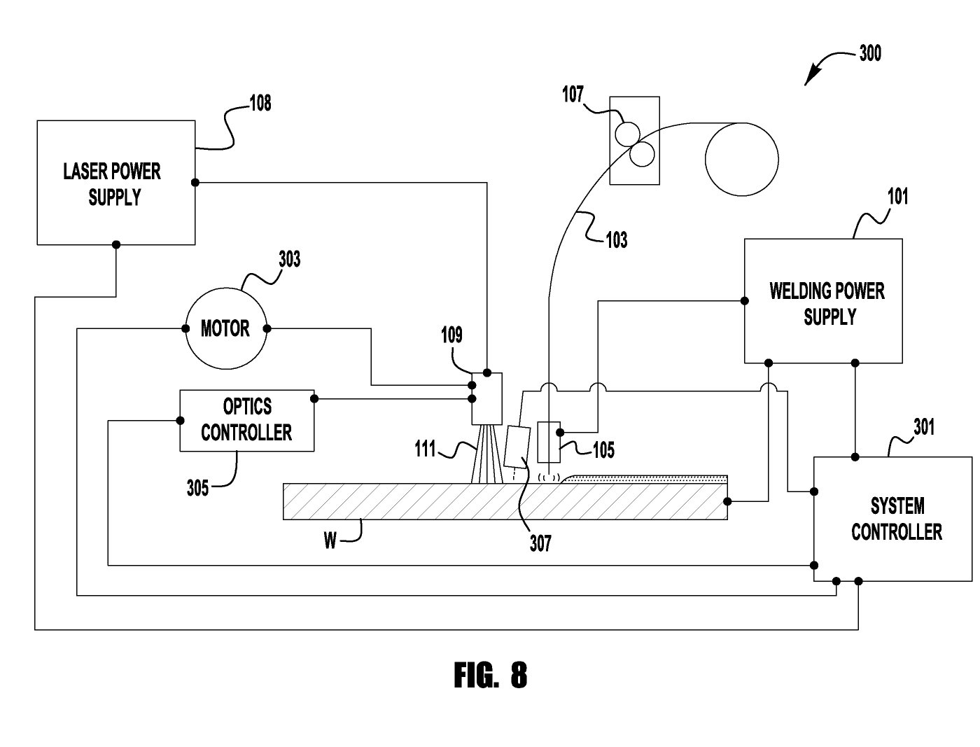

FIG. 8 depicts another exemplary embodiment of the present invention. The system 300 employs a system controller 301 which couples at least the welding power supply 101 with the laser power supply 108 so that the operation of these components can be synchronized. Such an embodiment can allow for the easy synchronization of these components during start-up, welding and stopping. Furthermore, the controller 301 can allow for adjustments of either or both of the laser power supply 108 or welding power supply 101 during a welding operation. That is, the controller 301 can direct the laser power supply 108 to provide a first power density for the laser beam for a first region of the weld and then a second power density (which is different) for a second region of the weld. Of course, the power density can remain the same but the size of the ablation area or zone can be changed as needed. Similarly he ablation pattern can change also from a first region to a second region of the weld joint, as needed. For example, a weld joint to be welded may have varying parameters during a single welding operation. Thus, the controller 301 can control the laser and welding operation appropriately. For example, it may be desirable to turn off the laser, or change the laser's energy level or beam shape, during welding. The controller 301 will allow these changes to occur during welding. Further, in some exemplary embodiments the laser 109 can be moved or oscillated by a motor 303 during welding as desired. Similarly, the optics of the laser 109 can be changed by an optics controller 305 during welding. This increases the flexibility of the system 300 and allows a complex weld joint to be welded in a single welding operation. For example, rather than using two beams to ablate at least two welding surfaces, the laser can be oscillated back-and-forth at a sufficient rate such that single beam 111 can sufficiently ablate multiple surfaces. Similarly, the optics of the laser can be controlled to change the shape of the beam 111 or beam density during welding.

It should be noted that although the controller 301 is depicted as a separate component in FIG. 8, the controller can be made integral to any of the welding power supply 101 or laser power supply 108 (as well as being a separate component).

In another exemplary embodiment, a temperature sensor 307 is positioned to sense the temperature of the surface of the work piece W at a point between the beam impact area and the arc welding operation. The sensor 307 is coupled to the controller 301 so that the controller 301 can monitor the temperature of the surface of the work piece W to ensure that the work piece is not being overheated during the ablation process. Thus, if the surface temperature is too high, the controller 301 will adjust the laser power supply 108 to reduce the energy/power density of the beam 111. This will prevent overheating or premature melting of the work piece.

In another exemplary embodiment, the sensor 307 shown in FIG. 8 can be a spectral sensor which is capable of determining the coating (such as zinc, paint, etc.) has been removed. Such spectral sensors can include laser induced plasma spectroscopy sensors or laser induced breakdown spectroscopy sensors. For example, the sensor 307 can be a spectral sensor that uses light or a laser beam to detect the presence of a material. In embodiments of the present invention, the sensor 307 can be calibrated to sense for the underlying base material, such as steel, to ensure that the coating is being sufficiently ablated. To the extent that it is detected that insufficient coating ablation is occurring the system, via the controller 301, can adjust the ablation appropriately. Further, the sensor 307 can also detect the spectral lines from the ablation plume to determine that the ablation plume (from the removal of the coating) is appropriate.

It should also be noted that although FIG. 8 depicts the cleaning and welding operation occurring simultaneously on a work piece W, embodiments are not limited to this. Specifically, in other exemplary embodiments of the present invention, the systems 200, 300 or 500 can be implemented where the cleaning operation is separated from the welding operation, but yet still be controlled as depicted. That is, it is contemplated that the cleaning operation occurs at a first station of a work cell, and the work piece(s) is transferred to a second station of a work cell (either robotically or manually) where the welding operation occurs. In fact, in the system 300 the system controller 301 can coordinate the transfer of the cleaned work piece from the first station to a second station.

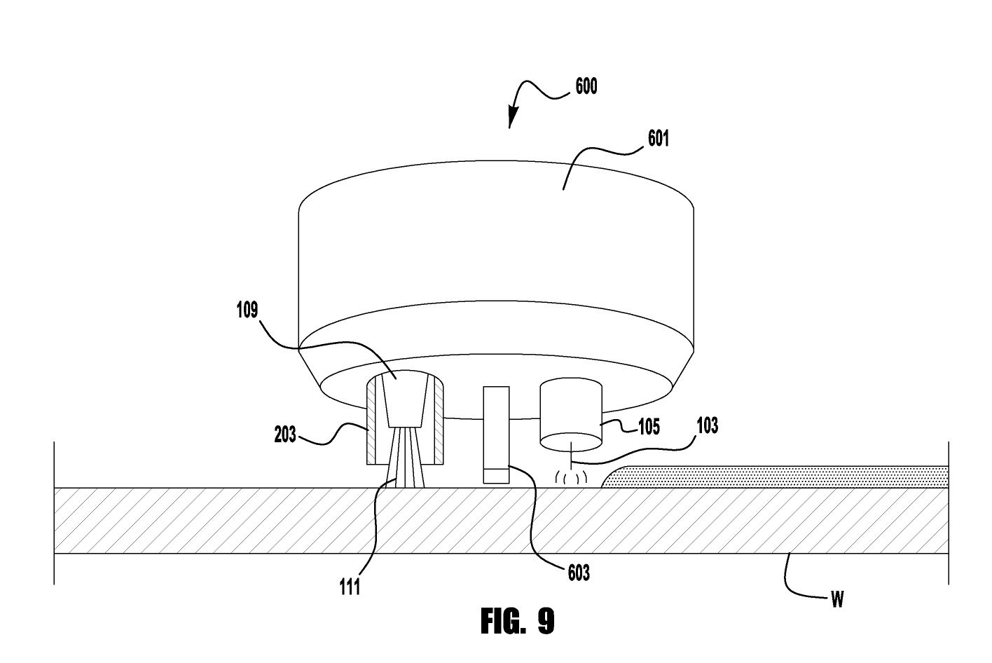

FIG. 9 depicts an integral welding head which can be used with exemplary embodiments of the present invention. In this embodiment the weld head 600 comprises a housing structure 601 which couples and contains the welding contact tip 105 and at least a portion of the laser 109 to direct the beam 111 to the work piece W. Such a housing 601 fixes the distance Z between the beam and the welding arc and can be used to simplify the welding operation. In some embodiments, the housing 601 also contains the vapor extraction nozzle 203 to facilitate the removal of any vaporized coatings. Not shown is a shielding gas nozzle or welding fume extraction nozzle which can also be coupled to the housing 601. In other embodiment, the temperature sensor 307 can also be coupled to the housing 601 and positioned such that it senses the surface of the work piece W between the beam 111 and the arc welding. The housing 601 can have a structure or configuration as needed for a specific welding operation. For example, the housing 601 can have a shielding (not shown) which protects the beam 111 and welding arc from external influences and contamination, where the shielding extends to very near the surface of the work piece. Further, the housing 601 can have a physical divider 603 between the arc and the beam 111 to prevent any contamination and prevent any vapor extraction from inadvertently removing shielding gas from the arc welding operation. The divider 603 can extend to very near the surface of the work piece.

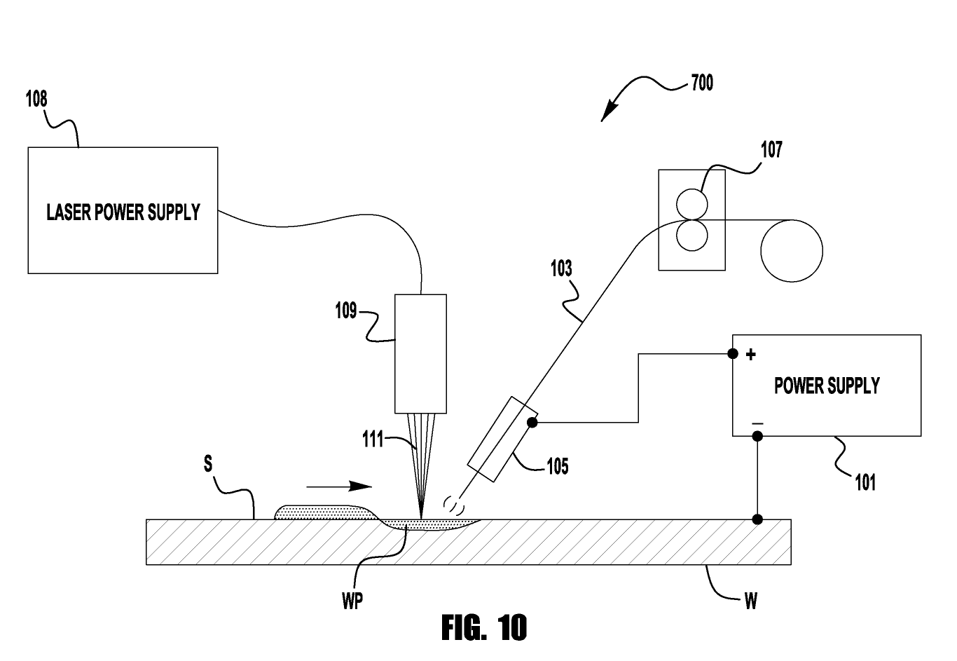

Further exemplary embodiments of the present invention are depicted in FIGS. 10 through 14, which are discussed in detail below. In these embodiments the laser beam 111 is directed to the weld puddle WP downstream of the arc welding event so as to add additional heat energy to the weld puddle WP. The additional heat energy maintains the weld puddle in a molten state longer than would normally occur during an arc welding process. By keeping the weld puddle in a molten state for a longer period of time any vaporized materials in the molten puddle will have more time to escape the weld puddle and still allow for the molten puddle to close around the escaping bubbles to form a weld joint with reduced porosity. As explained previously, arc welding coated materials can result in the trapping of vaporized materials in the weld joint. This is because the weld puddle solidifies before the bubbles can fully escape. However, in these embodiments of the present invention, the weld puddle is kept molten for a longer period of time giving more time for any trapped gasses to escape and the for the puddle to close around the escaping gasses. As discussed below, embodiments of the present invention accomplish this by irradiating the molten weld puddle with a laser beam to add additional heat energy to the weld puddle.

Turning now to FIG. 10, an exemplary system 700 is shown. The system 700 contains similar components to those described previously with respect to at least FIG. 5, and is operated and controlled in similar ways (as such, detailed discussion of these components will not be repeated here). However, as shown in FIG. 10, the laser 109 and the beam 111 are positioned in a trailing position behind the torch 105 such that the beam 111 is directed to the downstream portion of the weld puddle WP. The beam 111 is of an energy density sufficient to add heat to the weld puddle WP to maintain the puddle WP in a molten state longer than would normally be the case after the arc welding operation. That is, the energy of the beam 111 should be such that the heat provided from the beam 111, when combined with the heat existing in the puddle WP, extends the length of the weld puddle WP such that trapped gasses can escape during the welding operation. In the addition to regulating the energy density of the beam 111, exemplary embodiments of the present invention can also regulate the interaction time of the beam 111 with the puddle WP. That is, embodiments of the present invention can also regulate the size and movement (travel speed) of the beam 111 so that the beam 111 interaction time provides the desired energy input into the WP to achieve the desired results. Thus, embodiments of the invention can use the control methodology described above and herein to not only control the energy density of the beam, but also the interaction time—including but not limited to beam size, cross-section, travel/movement speed, etc. In an exemplary embodiment of the present invention, the interaction time should be no more than 5 mS. In another exemplary embodiment, the interaction time should be no more than 3.5 mS.

Because of this, embodiments of the present invention can achieve the performance attributes similar to the embodiments discussed with respect to FIGS. 1 through 9. That is, the embodiments represented in FIGS. 10 through 14 can achieve similar porosity, spatter, speed and deposition rate performance attributes discussed above, except that the beam 111 is irradiating the downstream side of the weld puddle as opposed to ablating the work piece prior to welding.

In exemplary embodiments of the present invention, the beam 111 has a power density below 10⁵ W/cm². In exemplary embodiments, the power density is at a level which keeps the surface molten, as desired, and does not keyhole through the puddle and workpiece.

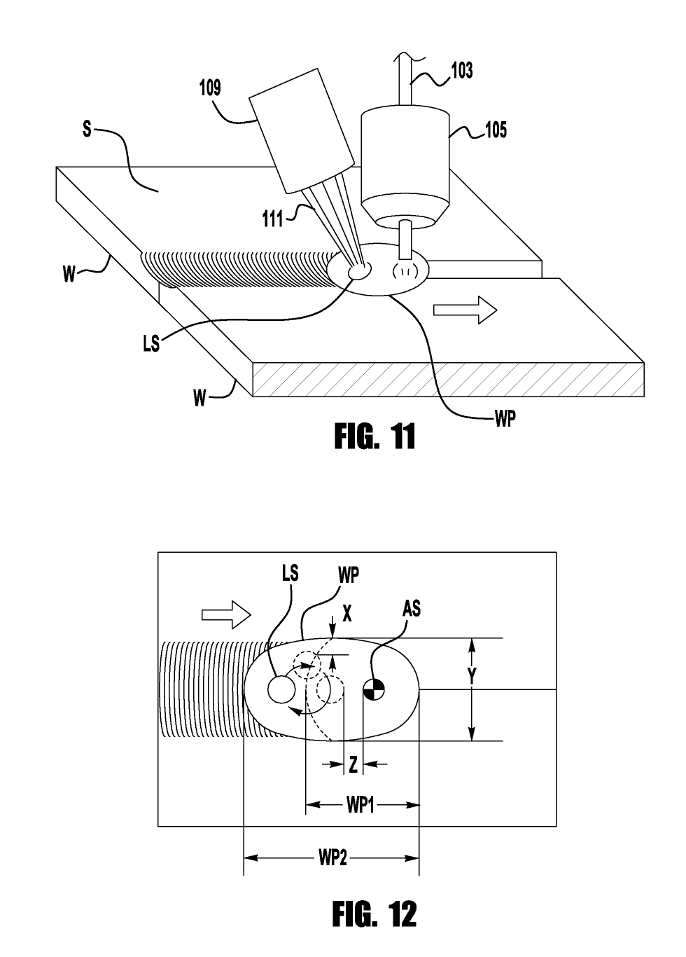

FIGS. 11 and 12 depict an exemplary welding operation and weld puddle created with embodiments of the present invention. As shown in FIG. 11, the beam 111 irradiates the weld puddle WP at a laser spot LS downstream of the arc welding operation. Not shown is the use of shielding gas, however embodiments of the present invention can be utilized with shielding gas as is generally known in the art.

FIG. 12 depicts a top-down view of the weld puddle WP during welding. Near the leading edge of the weld puddle WP is the arc spot AS which is the spot on the weld puddle WP where the welding arc contacts the weld puddle WP. During a stable welding operation the arc spot AS typically remains stationary relative to the borders of the weld puddle WP as the welding operation progresses. Downstream of the arc spot AS is the laser spot LS, which also impinges on the weld puddle WP. In some exemplary embodiments the laser spot LS remains stationary relative to the arc spot AS during welding such that the relative positioning between the two remain constant. However, in other exemplary embodiments the laser spot LS can be moved during the welding operation to irradiate different parts of the weld puddle WP during welding. In the embodiment shown in FIG. 12 the laser spot LS is moved in a circular pattern behind the arc spot AS. Of course, other patterns can also be used. For example, in other exemplary embodiments the spot LS can be scanned across the width and/or along the length of puddle as needed for the desired shape and length of the puddle. For example, it may be desired to increase the length of the puddle or create a specific puddle shape. As such, the interaction time of the spot LS can be controlled by changing the scan pattern and/or speed of the movement of the spot LS. This can be done to have a non-uniform energy input on the weld puddle. For example, in some embodiments it is desirable to have less heat input at the trailing edge of the weld puddle than near the leading edge. As such, the spot LS can be controlled to provide the non-uniform heat input into the weld puddle by changing the energy and/or interaction time of the beam.

In exemplary embodiments of the present invention, it is desirable to keep the laser spot LS relatively small as compared to the weld puddle WP. This will aid in preventing the weld puddle WP from being inadvertently widened by the laser beam 111. For example, in exemplary embodiments of the present invention, the laser post LS has a diameter which is in the range of 5 to 35% the width Y of the weld puddle WP during welding. In other exemplary embodiments, the laser spot LS has a diameter which is in the range of 10 to 25% of the width Y of the weld puddle WP during welding. Such diameters allow for sufficient heat input into the weld puddle without unnecessarily widening the width of the weld puddle WP. It should be noted that although the laser spot LS is shown having a circular cross-section in the figures, the present invention is not limited in this regard as other spot shapes can be utilized, including square, rectangular, etc. If non-circular shapes are used the diameter of the laser spot will be the diameter of a circle which has the same area of the laser spot being utilized. In other embodiments of the present invention, the spot LS can have a width up to 100% of the width of the weld puddle.

As also shown in FIG. 12 is the elongation of the weld puddle. Without the use of the laser beam 111 the weld puddle will have a first weld puddle length WP1, which would be the length of the weld puddle WP with just the welding operation and no additional external heat being provided to the puddle. The use of the laser beam 111 elongates the weld puddle WP to a second length WP2, which is longer than the first length WP1. In embodiments of the present invention, the laser beam 111 does this without increasing the width Y of the weld puddle WP. The second length of the weld puddle WP2 should be such that trapped gasses have the opportunity to escape the weld puddle WP during welding. However, the second length of the weld puddle WP2 should not be so much that the additional heat input appreciably compromises the integrity of the weld joint created. In exemplary embodiments of the present invention, the second weld puddle length WP2 is no more than 50% longer than the first weld puddle length. In further exemplary embodiments, the second weld puddle length WP2 is in the range of 20 to 45% longer than the first weld puddle length WP1. Such embodiments allow for sufficient time for trapped gasses to escape while not excessively heating the weld puddle.

Also shown in FIG. 12 is the relationship between the laser spot LS and the edge of the weld puddle and the arc spot AS. As stated above, in some exemplary embodiments the laser beam 111 does not create an increase in the width Y of the weld puddle WP. Thus, in some embodiments it is desirable to ensure that the laser spot LS does not get too close to the edge of the weld puddle WP during welding. In embodiments of the present invention, the laser spot LS is positioned (whether it is moving or not) such that a minimum distance X is maintained between the laser spot LS and the edge of the puddle WP. In embodiments of the present invention, the distance X is no less than 10% of the width Y of the weld puddle WP. In other exemplary embodiments, the distance X is no less than 20% of the width of the weld puddle. Of course, in other embodiments the spot LS can approach the sides of the weld puddle such that the distance X is near 0, but the interaction time and/or energy density of the spot LS should be such that the weld puddle is not inadvertently widened. In yet another exemplary embodiment, the laser can be defocused to flatten and/or spread out the weld puddle. For example, the laser beam can be defocused to flatten out the puddle to avoid the creation or ropey or narrow weld beads. In some of these embodiments the footprint of the defocused laser can overlap the weld puddle and impinge on the non-weld puddle portions of the work piece(s).

Further, in some embodiments of the invention or applications of use, it may be desirable to ensure that the beam 111 and/or the heat from the beam does not impinge on the arc during a welding operation. In such embodiments, the laser spot LS maintains a minimum distance Z behind the arc spot AS. In embodiments of the present invention, the distance Z is no less than 10% of the length WP2 of the weld puddle WP. In other exemplary embodiments, the distance Z is no less than 25%, and in further exemplary embodiments, the distance Z is in the range of 10 to 45%. The arc spot AS is generally the area on the weld puddle where the welding arc makes contact with the weld puddle WP. Whether or not this relationship between the arc spot AS and the laser spot LS is desirable can depend on the material being welded and the welding processing being employed, but is not necessary for all embodiments or applications of embodiments of the present invention.

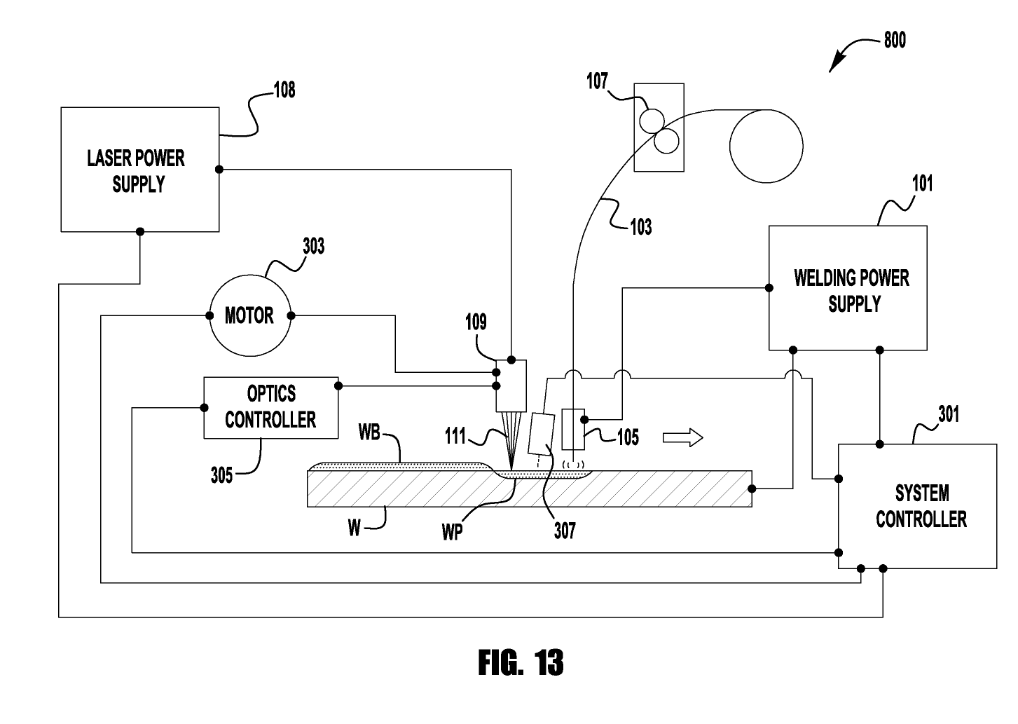

FIG. 13 depicts another exemplary system 800 of the present invention. The system 800 has similar components and construction to the system 300, shown in FIG. 8. As such, the discussion of those components is not repeated here. However, in the system 800 shown in FIG. 13 the welding torch 105 is upstream of the laser 109 and beam 111. Again, in this embodiment the beam 111 impacts the weld puddle WP to add energy to weld puddle as discussed above. Also shown in FIG. 13 is a temperature sensor 307 which is coupled to the system controller 301. The operation of the sensor 307 and controller 301 are similar to that discussed with respect to FIG. 8. However, in the system 800 the sensor 307 senses a temperature of the weld puddle WP during welding to determine an energy level of the beam 111 to be directed at the puddle WP. In an exemplary embodiment, for a given welding operation a puddle temperature is set in the controller 301 which is used by the controller 301 to maintain a desired puddle temperature via the beam 111. For example, if the detected puddle temperature is high the beam energy will be reduced, whereas if the detected temperature is low the beam 111 energy is increased to provide the needed energy into the puddle to increase the puddle length as needed.

Further, in other exemplary embodiments of the present invention, the system 800 (or similar systems) can be used to control the flatness of the weld bead WB. Thus, the system 800 can be used to control the heat input into the puddle to control the profile/flatness of the weld bead. The system 800 can monitor the heat input into the weld puddle WP to determine the bead profile and control the system to attain the desired bead profile. For example, the interaction time/energy density of the laser beam can be controlled to obtain the desired weld bead profile. In further embodiments, the sensor 307 can be a sensor which is capable of detecting the shape (height, width, length, etc.) of the weld bead, for example a visual sensor. Thus, the shape of the weld bead can be used to control the operation of the laser so that the desired shape is achieved. Such sensors are generally known and can include visual and/or thermal sensors.

In another exemplary embodiment of the present invention, the sensor 307 is positioned downstream of the beam 111 to detect the temperature of a trailing portion of the puddle or a region of the weld bead adjacent the weld puddle WP. In such an embodiment, the sensor 307 can be positioned to detect the temperature of the surface of the work piece W a set distance downstream of the welding arc. In one exemplary embodiment, the sensor 307 is positioned to detect the temperature of the edge of the weld puddle during welding. Based on the sensed temperature the controller 301 controls the energy output of the laser 109 to ensure the proper temperature is detected by the sensor 307, which indicates that the weld puddle WP has the proper size and temperature. For example, the sensor 307 is positioned to determine a surface temperature of the work piece at a set distance from the welding arc where it is desired that the surface of the work piece at the detection point is desired to be in a molten state. If the detected temperature is below the temperature set point, which indicates that the weld puddle WP may not be long enough, the controller 301 signals the power supply 108 to increase the beam energy 111 to increase the energy into the puddle WP so that the desired length is achieved. Similarly, if the detected temperature is too high, the controller 301 causes the laser energy to be reduced.

The control of the heat input from the laser 109 and beam 111 to the weld puddle WP can be achieved in a number of different ways. That is, embodiments of the present invention can use various control methodologies to vary the heat input from the beam 111. Examples can include any one, or a combination of, the following: (1) pulsing the beam 111 and/or changing the pulse rate of the beam 111 to change the heat input; (2) changing the cross-sectional shape or size of the beam to change the energy density of the beam 111 when it contacts the puddle; (3) increasing or decreasing the energy density of the beam 111 without changing its shape; and (4) changing the positioning or movement of the beam 111 relative to the welding arc.

In other exemplary embodiments, other types of sensors can be used to control the output of the laser 109. For example a visual sensor can be used which detects the transition from a molten weld puddle WP to the solidified weld bead WB, such that the beam 111 is controlled such that the transition region between the puddle and the bead is maintained at the desired location or distance from the welding arc. Optical systems used to monitor the shape of a weld puddle are generally known and need not be discussed in detail herein. Further, a line scan system (as an exemplary system) can be used which identifies the presence of pores on the surface of the molten puddle and based on the detection of pores the heat input from the laser can be controlled. In other embodiments, a weld monitoring software/system can be employed to monitor the porosity/quality of the weld. An example of such a system is the Weld Score™ quality monitoring system from The Lincoln Electric Co. of Cleveland, Ohio. In a further exemplary embodiment, the line scan system can also be utilized to detect the presence/amount of pores in the resultant weld bead created by the puddle, and based on the detection of pores (for example, over a threshold amount) the laser can be controlled to modify the puddle to reduce the amount of pores detected. Such a system can be a structured light (laser line) system which scans the surface of the weld bead after solidification for pores or porosity, and then based on feedback from this system the process can be modified to reduce porosity in the bead. For example, the laser interaction time can be modified.

In exemplary embodiments of the present invention, the set point utilized by the controller 301 (whether temperature or other type) is determined based on welding input information. For example, embodiments of the present invention can use at least one of welding current, travel speed, wire feed speed, welding power, welding voltage, consumable type, and work piece type (e.g., mild steel, stainless, etc.) to determine a set point for operation. The set point can be selected based on the use of state tables or via an algorithm, or any other method to create a desired set point. During welding the detected feedback is compared to the set point to control the output of the laser 109 to ensure that a desired weld puddle WP is achieved. For example, a user inputs information into the welding power supply 101 and/or the system controller 301, which can include the information described above, about a welding operation. A control algorithm, state-table, look-up table, or the like, in the controller 301 determines that the weld puddle WP must have a set temperature and/or be in a molten state at a distance downstream of the welding arc to ensure that the weld puddle has a length which allows benefits of the present invention to be achieved. During welding the sensor 307 monitors the puddle and/or work piece surface at this distance to ensure that the desired set point is maintained. If the feedback from the sensor 307 (such as a temperature reading) is not consistent with the desired set point then the controller 301 causes a characteristic of the beam 111 or the operation of the laser 109 to change so that the desired set point is achieved.

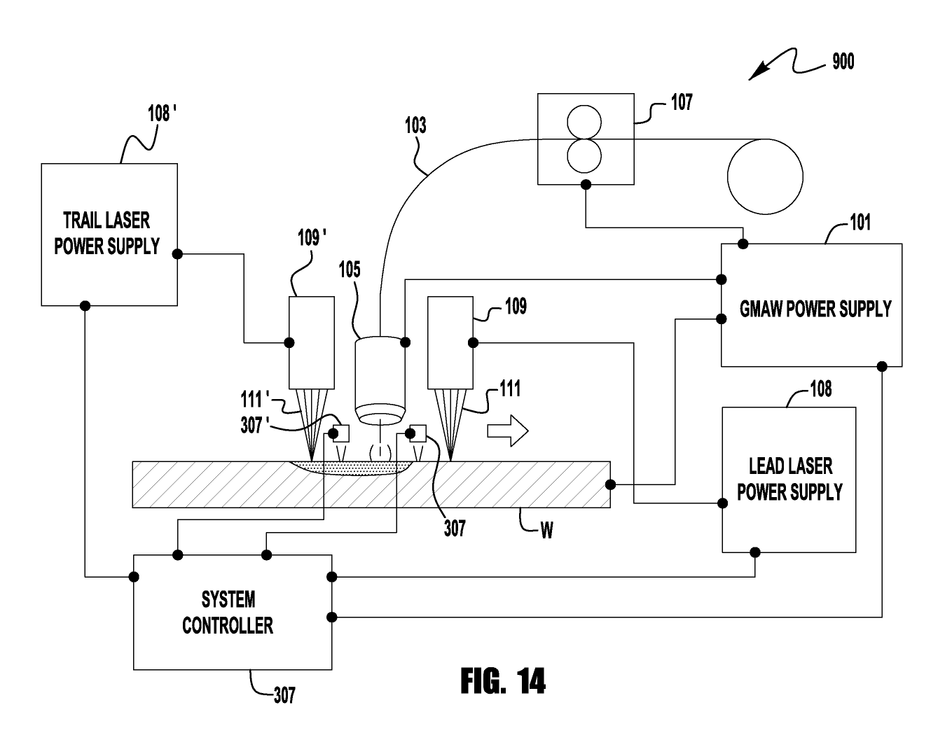

FIG. 14 depicts an additional welding system 900 of the present invention, where at least two laser beams 111 and 111′ are used for the welding operation. That is, the system 900 comprises a first laser 109 and a second laser 109′. The first laser 109 is coupled to a first laser power supply 108 and is operated to irradiate the work piece prior to welding as described herein, and the second laser 109′ is coupled to a second laser power supply 108′ and is operated to irradiate the weld puddle WP as described herein. In such an embodiment, the two laser beams 111 and 111′ work together to aid in minimizing porosity and spatter while increasing the welding speed of the operation. Such embodiments can be used to achieve the performance levels described herein, but distribute the required laser energy density over the use of two lasers 109 and 109′. Also as shown in FIG. 14, multiple sensors 307 and 307′ can be utilized on either side of the welding arc, and be operated consistent with the discussion of the sensors described herein to control the output of the lasers 109 and 109′.

It is also noted that exemplary embodiments of the present invention utilizing a laser downstream of the welding arc can be similar in construction and operation to embodiments shown in FIGS. 7 and 9, except that the beam 111 is irradiating the weld puddle as described above with respect to FIGS. 10 through 14.

It should be noted that the lap joint welds depicted in the present application are intended to be exemplary as embodiments of the present invention can be used to weld many different types of weld joints. There are many different types of weld joints which can lead to the capture of vaporized coatings in the weld bead, and embodiments of the present invention can be adapted and employed for those types of weld joints as well.

While the invention has been particularly shown and described with reference to exemplary embodiments thereof, the invention is not limited to these embodiments. It will be understood by those of ordinary skill in the art that various changes in form and details may be made therein without departing from the spirit and scope of the invention as defined by the following claims.

What is claimed is:

1. A method of welding, comprising:
welding at least one work piece with an arc welding process such that a liquid weld puddle is created from said at least one work piece, where said welding is being performed in a travel direction; and
directing an energy beam to a surface of said weld puddle downstream of said arc welding process, relative to said travel direction, such that said energy beam adds heat energy to said weld puddle to modify a shape of said weld puddle;
wherein a weld joint created by said welding and directing steps has a cross-sectional porosity of no more than 30% and a length porosity of no more than 30%.

2. The method of claim 1, wherein said energy beam is a laser beam having a power density of no more than 10⁵ W/cm².

3. The method of claim 1, wherein said energy beam is moved relative to said arc welding process during said welding.

4. The method of claim 1, wherein said energy beam has a width at said weld puddle which is in the range of 5 to 35% of a maximum width of said weld puddle.

5. The method of claim 1, wherein said weld puddle has a total length which is no more than 50% longer than a weld puddle created by said arc welding process alone.

6. The method of claim 1, wherein a minimum distance between an edge of said weld puddle and an edge of a spot created by said energy beam on said weld puddle is no less than 10% of the maximum width of said weld puddle during welding.

7. The method of claim 1, wherein a minimum distance between an edge of a spot created by said energy beam on said weld puddle and an arc spot on said weld puddle created by said arc welding process is no less than 10% of a maximum length of said weld puddle.

8. The method of claim 1, further comprising sensing a temperature of at least one of a surface of said weld puddle and a surface of said work piece and changing an operation of said energy beam in response to said sensed temperature.

9. The method of claim 1, further comprising detecting a shape of a weld bead created by said welding and directing and changing an operation of said energy beam in response to said detected shape.

10. The method of claim 1, further comprising detecting porosity in a surface of at least one of said weld puddle and a weld bead formed by said weld puddle and changing an operation of said energy beam in response to said detected porosity.

11. The method of claim 1, wherein said energy beam has an interaction time of no more than 5 mS.

12. The method of claim 1, wherein said work piece has a coating on a surface of said work piece to be welded during said welding.

13. The method of claim 1, wherein at least one of said cross-sectional porosity and said length porosity is no more than 10%.

14. A welding system, comprising:
an arc welding power supply coupled to an arc welding torch for performing an arc welding operation on a work piece to create a weld joint, where during said arc welding operation a weld puddle is created; and
an energy beam power supply coupled to an energy beam source which directs an energy beam at a surface of said weld puddle downstream of said arc welding operation, in a travel direction,
wherein said energy beam has an energy density and/or interaction time sufficient to add heat energy to said weld puddle; and
wherein said system creates a weld joint having a cross-sectional porosity of no more than 30% and a length porosity of no more than 30%.

15. The system of claim 14, wherein said energy beam is a laser beam having a power density of no more than 10⁵ W/cm².

16. The system of claim 14, further comprising an energy beam movement device which moves said energy beam relative to said arc welding process during welding.

17. The system of claim 14, wherein said energy beam has a width at said weld puddle which is in the range of 5 to 35% of a maximum width of said weld puddle.

18. The system of claim 14, wherein said weld puddle has a total length which is no more than 50% longer than a weld puddle created by said arc welding operation alone.

19. The system of claim 14, wherein a minimum distance between an edge of said weld puddle and an edge of a spot created by said energy beam on said weld puddle is no less than 10% of the maximum width of said weld puddle during welding.

20. The system of claim 14, wherein a minimum distance between an edge of a spot created by said energy beam on said weld puddle and an arc spot on said weld puddle created by said arc welding operation is no less than 10% of a maximum length of said weld puddle.

21. The system of claim 14, further comprising a temperature sensor which senses a temperature of at least one of a surface of said weld puddle and a surface of said work piece, and wherein an operation of said energy beam is changed in response to said sensed temperature.

22. The system of claim 14, further comprising a detection device positioned adjacent to said arc welding operation which detects a shape of a weld bead created from said weld puddle, and wherein an operation of said energy beam is changed in response to said detected shape.

23. The system of claim 14, further comprising a surface porosity detection device which detects porosity in a surface of at least one of said weld puddle and a weld bead formed by said weld puddle, and wherein an operation of said energy beam is changed in response to said detected porosity.

24. The system of claim 14, wherein said energy beam has an interaction time of no more than 5 mS.

25. The system of claim 14, wherein said work piece has a coating on a surface of said work piece to be welded during said welding.

26. The system of claim 14, wherein at least one of said cross-sectional porosity and said length porosity is no more than 10%.
